(19) United States
(12) Patent Application Publication
(10) Pub. No.: US 2011/0266326 A1
(43) Pub. Date: Nov. 3, 2011

(54) CUTTING DEVICE FOR CUTTING GRAPHENE AND A METHOD FOR CUTTING GRAPHENE USING A CUTTING DEVICE

(76) Inventors: Jürgen P. Rabe, Berlin (DE); Nikolai Severin, Berlin (DE); Stefan Kirstein, Berlin (DE)

(21) Appl. No.: 13/127,018

(22) PCT Filed: Oct. 29, 2009
(86) PCT No.: PCT/DE2009/001513

§ 371 Date: Jul. 20, 2011

(30) Foreign Application Priority Data
Oct. 29, 2008 (DE) 10 2008 053 691.1

(51) Int. Cl. B26F 3/00

(52) U.S. Cl. 225/103

(57) ABSTRACT

The invention relates to a cutting device for cutting graphene, with a receptacle (10) which is configured to accommodate the graphene (19) for cutting, a cutting element (12) which is loaded with a catalytically active material, at least in the region of a cutting tip, a shifting apparatus, which is configured for shifting the receptacle (10) and the cutting element (12) with the cutting tip relatively to one another, and a heating device (14), which is configured to supply thermal energy during the cutting of the graphene (19) for a catalytic reaction of the graphene in the region of a cutting path with the participation of the catalytically active material.

The invention relates to a cutting device for cutting graphene and a method for cutting graphene using a cutting device.

### BACKGROUND OF THE INVENTION

Graphene is a material which consists of thin single-atom layers of sp²-hybridised carbon, which leads to a honeycomb-like arrangement of the atoms. Its manufacture has only recently been reported on (K. S. Novoselov et al., Proceedings of the National Academy of Sciences of the United States of America 102, 10451 (2005)). In the future, graphene may replace silicon as the most important material in electronics, as it is superior to silicon in various respects. For example, graphene has an electron mobility which is two orders of magnitude higher than silicon, it is very thin, and, what is most important, it is possible to cut an electronic circuit from a single piece of graphene. It has already been proven that it is possible to produce a functional transistor from graphene. As silicon electronics has reached its limits in many respects, graphene is attracting increasing interest. The current difficulties in the field of graphene electronics are first a reliable production of graphene on insulating substrates and then the cutting of the electronic circuits with satisfactory precision. There is currently no lithographic method for this. The best currently known lithographic method is electron beam lithography (EBL). However, it will not be possible in the near future to produce an electronic circuit from a single graphene layer using electron beam lithography.

A method for cutting graphene which is present in the form of nanotubes is described in the document U.S. 6,869,581 B2. A thin film of metal, which is suitable for promoting a catalytic reaction of carbon with the oxygen of a surrounding atmosphere, is applied to a substrate. The metal film applied on the substrate is subjected to a heat treatment, so that the metal film melts down to form metal particles. After the metal particles have formed from the metal, nanotubes made of graphene are applied onto the substrate prepared in this manner, in that a solution, in which nanotubes are located, is sprayed onto the substrate. In a subsequent step, the substrate with the metal particles and the nanotubes is then subjected to a heat treatment in an oxygen atmosphere. At the points where a nanotube came to lie on a metal particle, the catalytically active metal brings about a reaction of the carbon in the nanotubes with the oxygen of the surrounding atmosphere, so that the nanotubes are cut up at this point. It is disadvantageous in this method that cutting a nanotube is not possible at a predetermined point, rather cutting takes place randomly. It is not possible to achieve a predeterminable shaping of graphene using the method described.

### SUMMARY OF THE INVENTION

It is an object of the invention to provide an improved device for cutting graphene and an improved method for cutting graphene using a cutting device, particularly for flexible cutting of graphene.

This object is achieved according to the invention by a cutting device for cutting graphene according to the independent claim 1. Furthermore, a method for cutting graphene using a cutting device according to the independent claim 8 is provided. Advantageous embodiments of the inventions are the subject of dependent sub-claims.

The invention comprises the idea of a cutting device for cutting graphene, which is provided with a receptacle which is configured for accommodating the graphene for cutting. The cutting device has a cutting element, which is loaded with a catalytically active material at least in the region of a cutting tip, and a shifting apparatus, which is configured for shifting the receptacle and the cutting element with the cutting tip relatively to one another. In the following, “catalytically active material” is in particular understood to be a material which promotes a reaction of the carbon in the graphene with a further substance, for example oxygen surrounding the graphene. The “promoting of a reaction” here means an acceleration of the reaction or a reduction of the activation energy for the start of the reaction in particular. A heating device is provided, which is configured to supply thermal energy during the cutting of the graphene for a catalytic reaction of the graphene in the region of a cutting path with the participation of the catalytically active material.

Therefore, a flexible cutting of graphene is enabled, so that predeterminable contours in particular can be realised for cuts in graphene. Thus, it is for example possible to produce an electronic circuit based on graphene.

In a preferred embodiment, in the case of the cutting element, the catalytically active material can be arranged on a surface of the cutting tip. In an alternative embodiment, in the case of the cutting element, the cutting tip can be formed of the catalytically active material at least in sections.

A preferred development of the invention provides for the cutting element to be formed with a tip of a probe microscope. This may advantageously be a suitably formed tip, for example a cantilever tip of a scanning force microscope or a tip of a scanning tunneling microscope. It may further be advantageous to provide for the tip to be produced entirely of a catalytically active material. In this manner, a problem of different thermal expansions, which may arise when using materials with different coefficients of thermal expansion, can at least be moderated, for example. This can in particular prevent a problem arising with respect to a contaminating layer on the graphene. By way of example, the tip is produced entirely of tungsten, but other catalytically active materials such as for example metals or alloys thereof can also be provided.

In a further preferred embodiment, the catalytically active material can comprise at least silver particles or at least tungsten particles. The metals gold, copper, lead, potassium, barium, calcium, sodium, lithium, vanadium, nickel or alloys thereof are also considered for example, as is a use of one or a plurality of metal oxides as well, for example. It is preferred that the selected catalytically active material enables the conversion of the carbon in graphene into volatile carbon compounds in particular, such as for example CO or CO₂ in the presence of gaseous oxygen, but the formation of other volatile carbon compounds on the basis of a reaction with a suitable reaction partner such as hydrogen or steam for example is also considered.

In an expedient embodiments, the heating device may be configured to set a reaction temperature for the catalytic reaction in a range between approximately 500° C. and approximately 1000° C., preferably between approximately 600° C. and approximately 900° C., more preferably between approximately 650° C. and approximately 800° C. This can be achieved for example by correspondingly increasing a temperature of the graphene at the region where it is to be cut next. It is however also possible to heat up the cutting element or the cutting tip directly using the heating device, so that cutting the graphene on the basis of the catalytic reaction, as described above, is enabled. Provision may also be made for the heating device to heat both the cutting element and the graphene to be cut.

In an advantageous embodiment, the heating device can comprise a laser as heating means. A beam of the laser can be diverted and guided in such a manner that it flexibly provides the desired regions with the thermal energy for the catalytic reaction.

Another aspect of the invention provides a method for cutting graphene using a cutting device. According to this method, the graphene is initially provided on a receptacle in the cutting device. The graphene can for example be present on an insulating substrate. Hereafter, a cutting element, at least a cutting tip of which is loaded with a catalytically active material, is guided onto the graphene. A heating device is operated in order to provide thermal energy for a catalytic reaction for cutting the graphene. In order to cut the graphene along a predetermined path, the receptacle and the cutting element are shifted relatively to one another along a cutting path. Cutting the graphene along the cutting path is effected by the catalytic reaction taking place in the graphene along the cutting path, supported by the catalytically active material and the thermal energy. Incidentally, the method for cutting graphene can in particular be carried out using the previously described cutting device and the various embodiments.

It is possible to cut graphene in a flexible manner using the cutting device for cutting graphene and method for cutting graphene using a cutting device. In particular, it is possible to predetermine cutting contours and reproducibly implement them. Further, cuts with a roughness of less than 2 nm can be produced. The cutting procedure can be carried out at high speed. The reaction products are harmless or can readily be made harmless. Further, the cutting of graphene using the cutting device and the method is possible relatively inexpensively, as no ultra-high vacuum apparatuses, as are required for example for electron beam lithography, are required.

### DESCRIPTION OF PREFERRED EMBODIMENTS OF THE INVENTION

The invention is explained in more detail in the following on the basis of preferred exemplary embodiments with reference to figures of a drawing. In the figures:

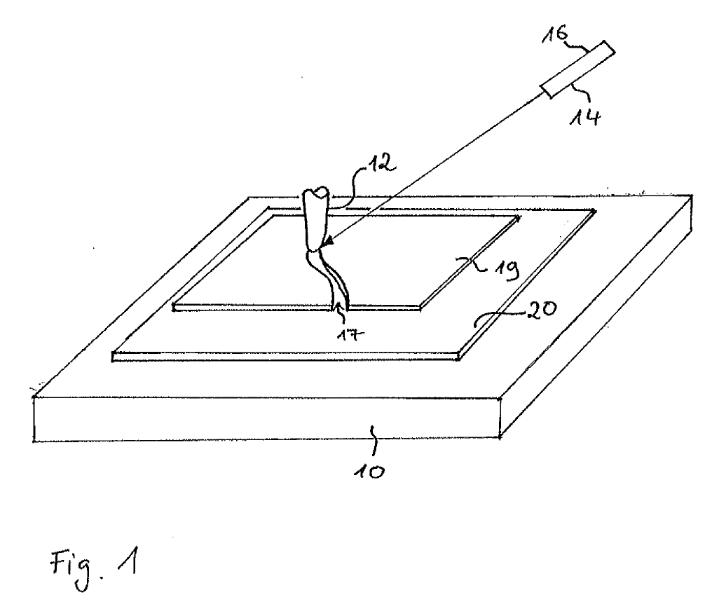

FIG. 1 shows a cutting device for cutting graphene in a schematic illustration,

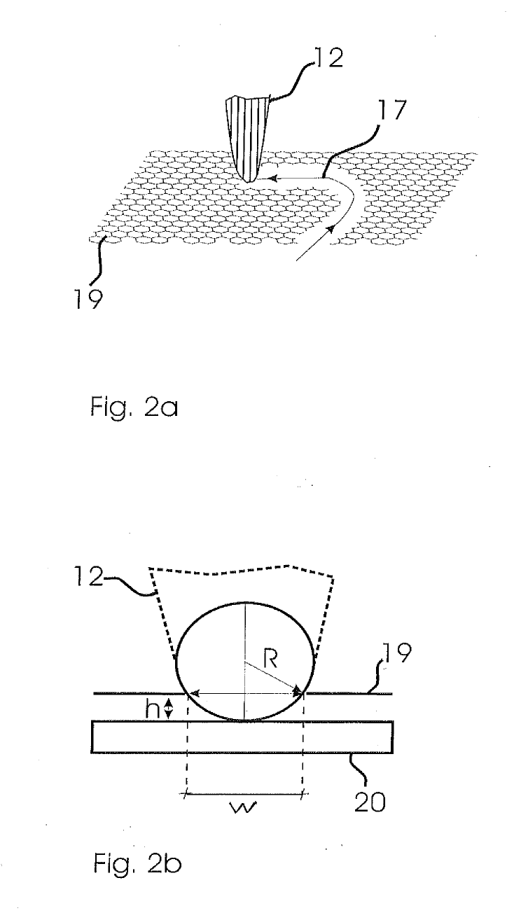

FIG. 2a shows a further schematic illustration of a cutting procedure with a cutting element of the cutting device,

FIG. 2b shows a schematic illustration for explaining the connection between a graphene thickness, a radius of curvature of the cutting element at its cutting tip and the width of a cut achieved, and

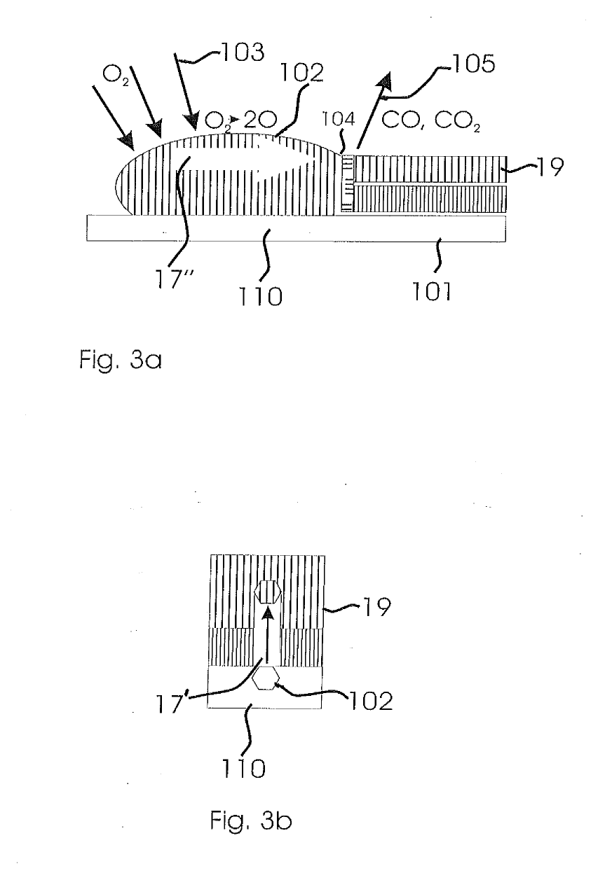

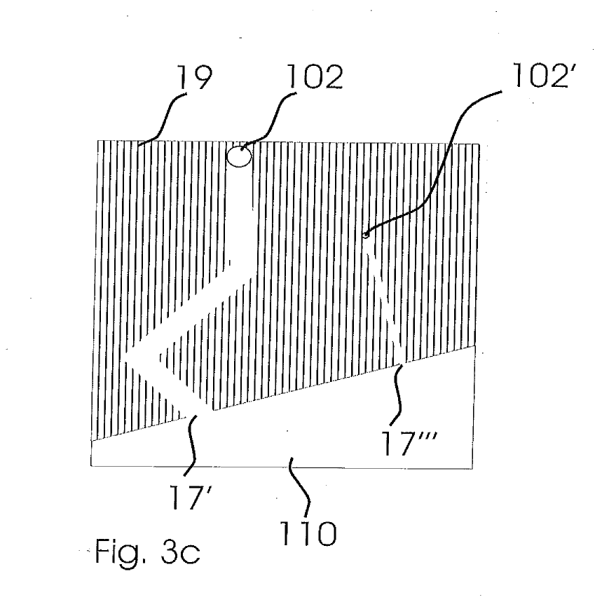

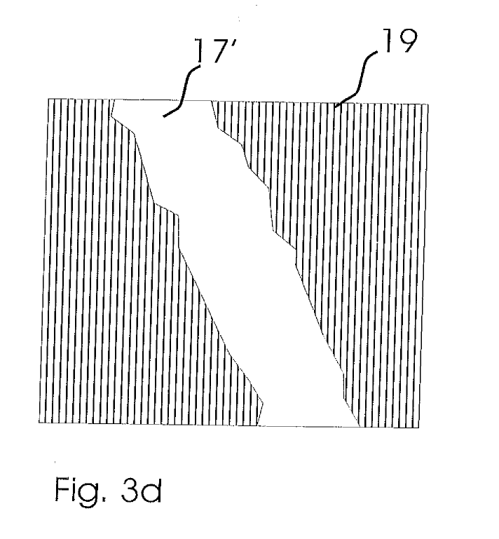

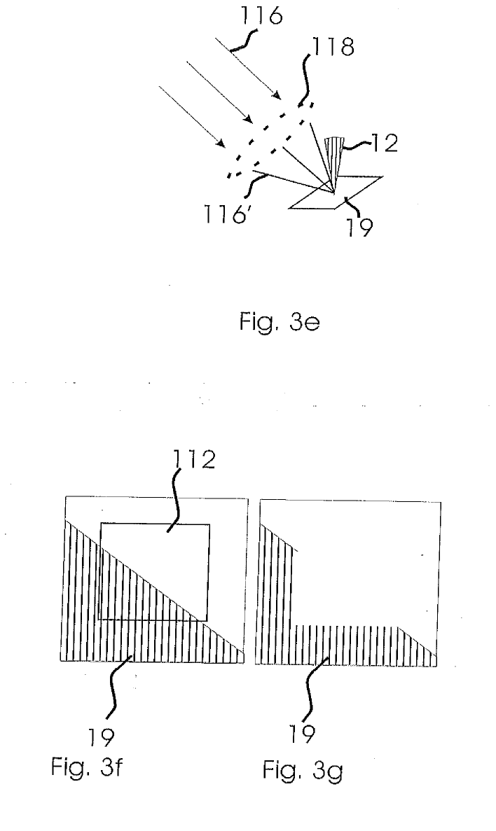

FIGS. 3a-g show experimental results and a further schematic illustration of a cutting procedure in an embodiment.

FIG. 1 shows a cutting device for cutting graphene. A receptacle 10 is configured to accommodate the graphene 19 for cutting. The graphene 19 is for example arranged on an insulating substrate 20. A cutting element 12 is loaded with a catalytically active material, at least in the region of a cutting tip. The cutting tip of the cutting element 12 is formed of catalytically active silver at least in sections in this embodiment. Alternatively, it can be provided, in the case of the cutting element, for the catalytically active material to be arranged only on a surface of the cutting tip. Further, gold, copper, tungsten or lead may also be considered as catalytically active materials. The cutting element is formed using a tip 12 of a probe microscope (not shown here). A shifting apparatus (not shown here), which is provided by means of the probe microscope here, is configured to shift the receptacle 10 and the cutting element 12 relatively to one another. Further, the cutting device comprises a heating device 14, which is configured to supply thermal energy during the cutting of the graphene 19 for a catalytic reaction of the graphene in the region of a cutting path with the participation of the catalytically active material. The heating device 14 can comprise a laser 16 as heating means, the beam of which can be directed onto the cutting element 12. It is however also possible to provide for the laser beam to radiate onto the graphene 19, into the region which is to be cut next or heat up both alternately. The heating device 14, such as for example the laser 16, is configured to set a reaction temperature for the catalytic reaction in a range between approximately 500° C. and approximately 1000° C., preferably between approximately 600° C. and approximately 900° C., more preferably between approximately 650° C. and approximately 800° C.

FIG. 2a clarifies a cutting procedure with a cutting element of a cutting device. The same or similar reference numbers mean the same or similar components in the following. In FIG. 2a, it is shown how a cut 17 is produced in graphene 19 along a predetermined path 17 using a cutting element 12. In detail, the procedure is as follows. First, the graphene 19 is provided on a receptacle (not shown here) in the cutting device. The graphene 19 can for example be present on an insulating substrate (not shown here). Hereafter, the cutting element 12, at least a cutting tip of which is loaded with a catalytically active material, is guided onto the graphene 19. A heating device is operated (not shown here) in order to provide thermal energy for a catalytic reaction for cutting the graphene. In order to cut the graphene 19 along a predetermined path, the receptacle and the cutting element 12 are shifted relatively to one another along a cutting path. Cutting the graphene 19 along the cutting path 17 is effected by the catalytic reaction taking place in the graphene along the cutting path 17, supported by the catalytically active material and the thermal energy. Incidentally, the method for cutting graphene can in particular be carried out using the previously described cutting device.

FIG. 2b shows a schematic illustration for explaining the connection between a height h of graphene 19 located on a substrate 20, a radius of curvature R of a cutting tip of a cutting element 12 and a width w of the trench created. The width w of the trench created can thus be estimated on the basis of geometric considerations in accordance with ω=2\sqrt{P²−(P−η)²}. Currently available cutting element tips have a radius R of approximately 1 nm, the interlayer spacing in highly-orientated pyrolytic graphite of approximately 0.34 nm is used as height h of a graphene layer, so an estimate of approximately 1.5 nm results for a width w of the trench created in the graphene.

FIG. 3a shows from one side how a particle 102 works a trench 17′ into a graphene layer 19 arranged on a base layer 110. This procedure appears in an experiment described as follows. Catalytically active nanoparticles were formed from an aqueous solution using catalytically active metal salts on highly-orientated pyrolytic graphite (HOPG). The nanoparticles congregate to the greatest extent at defects of the graphite surfaces, such as for example at step edges. After annealing the sample in an oven preheated to 650° C. for a duration of up to one minute, the HOPG samples were cooled and investigated using a scanning force microscope (SFM) or using a scanning tunnelling microscope (STM). The observations showed that the nanoparticles had formed relatively long channels or trenches in the HOPG samples. High-resolution STM images of the channels show that the edges of the channels are very smooth, a roughness of less than 2 nm being present. This effect is explained as follows. Carbon atoms at the edges of graphene have a greater tendency towards oxidation than carbon atoms within the graphene. Thus, a particle arranged at the graphene edge accelerates the oxidation of adjacent carbon atoms at the edge to a high degree, whilst the carbon atoms in the graphene layer below the particle do not oxidise. The catalytically active particle moves into the graphene layer lying therebelow, whereby it quasi burns the graphene in front of it and at the same time leaves a trench behind it. The speed of the movement of the particle is to a great extent dependent on the material and the size of the particle. The speed of the movement of the particle can, however, also be dependent on an environmental pressure, for example the pressure of the reaction partners, i.e. of the surrounding gas or steam. FIG. 3a shows the processes in the catalytic reaction in detail. A catalytically active particle 102 which is located at a step edge 104 of the HOPG allows oxygen molecules to accumulate on its surface by means of chemisorption, 103, atomic oxygen also being formed. The atomic oxygen diffuses in the direction of the graphene edge 104 and reacts with the carbon atoms touching the particle at 104. Gaseous reaction products desorb, 105, and the particle follows the retreating graphene edge 17″.

FIG. 3b shows a view from above of the trench 17′ left behind by a catalytically active particle 102. The particle initially located at the step edge (indicated by the dashed contour) moves through the graphene layers, whereby it leaves a trench 17′ behind itself.

FIG. 3c shows a catalytically active particle 102 which has dug in a zig-zag movement 17′ through a HOPG material and a considerably smaller catalytically active particle 102 which has dug rectilinearly 17″′ through the HOPG. FIG. 3d shows a trench 17′ left generated by a catalytically active particle in detail. Here, it can be seen that the trench 17′ has a slight inner roughness. The resulting inner roughness has a value in an order of magnitude of two nanometres, as was confirmed by high-resolution STM images.

FIG. 3e is a further illustration of a cutting device, in which a laser beam 116 of a heating device comprising a laser as heating means is focussed onto the reaction region by means of a lens 118, where a catalytically active material located on a cantilever tip 12, constructed as a cutting element 12, of a probe microscope promotes oxidation of the carbon of a graphene layer 19.

FIGS. 3f and 3g show a sketch of a HOPG region, a graphene layer 19 lying on another graphene layer. FIG. 3f shows the result after irradiation with a moderate laser intensity, whereby the scanning area was then reduced, 112, as is indicated with the dashed line, then the laser intensity was increased, the area was scanned a number of times, then the laser intensity was reduced to the moderate level again and the scanning area was enlarged to the initial value. FIG. 3g shows that graphene was oxidised during the scanning with the high laser intensity.

The features of the invention disclosed in the above description, the claims, and the drawings can be of significance individually as well as in any combination for the implementation of the invention in its different embodiments.

1. A cutting device for cutting graphene, comprising:
a receptacle which is configured to accommodate the graphene (19) for cutting,
a cutting element which is loaded with a catalytically active material, at least in the region of a cutting tip,
a shifting apparatus, which is configured for shifting the receptacle and the cutting element with the cutting tip relatively to one another, and
a heating device, which is configured to supply thermal energy during the cutting of the graphene for a catalytic reaction of the graphene in the region of a cutting path with the participation of the catalytically active material.

2. The device according to claim 1, wherein for the cutting element, the catalytically active material is arranged on a surface of the cutting tip.

3. The device according to claim 1, wherein for the cutting element, the cutting tip is formed of the catalytically active material at least in sections.

4. The device according to claim 1, wherein the cutting element is formed using a tip of a probe microscope.

5. The device according to claim 1, wherein the catalytically active material comprises at least silver particles or at least tungsten particles.

6. The device according to claim 1, wherein the heating device is configured to set a reaction temperature for the catalytic reaction in a range between 500° C. and 1000° C., using the thermal energy provided.

7. The device according to claim 1, wherein the heating device comprises a laser as heating means.

8. A method for cutting graphene using a cutting device, wherein the method comprises the following steps:
providing the graphene on a receptacle of the cutting device,
guiding a cutting element, at least a cutting tip of which is loaded with a catalytically active material, onto the graphene,
operating a heating device in order to provide thermal energy for a catalytic reaction during the cutting of the graphene, and
shifting the receptacle and the cutting element with the cutting tip relatively to one another along a cutting path, and cutting the graphene along the cutting path by the catalytic reaction taking place in the graphene along the cutting path, supported by the catalytically active material and the thermal energy.

9. The method according to claim 8, wherein the cutting element is brought into contact with the graphene for cutting the graphene.

10. The method according to claim 8, wherein a cutting element, in the case of which the catalytically active material is arranged on a surface of the cutting tip, is used as cutting element.

11. The method according to claim 8, wherein a cutting element, in the case of which the cutting tip is formed of the catalytically active material at least in sections, is used as cutting element.

12. The method according to claim 8, wherein a tip of a probe microscope is used as cutting element with cutting tip.

13. The method according to claim 8, wherein at least silver particles or at least tungsten particles are used as the catalytically active material.

14. The method according to claim 8, wherein the heating device sets a reaction temperature for the catalytic reaction in a range between approximately 500° C. and approximately 1000° C.

15. The method according to claim 8, wherein a laser is used as heating means in the heating device.

16. The device according to claim 6, wherein the heating device is configured to set a reaction temperature for the catalytic reaction in a range between 600° C. and 900° C., using the thermal energy provided.

17. The device according to claim 16, wherein the heating device is configured to set a reaction temperature for the catalytic reaction in a range between 650° C. and 800° C., using the thermal energy provided.

18. The method according to claim 14, wherein the heating device sets a reaction temperature for the catalytic reaction in a range between approximately 600° C. and approximately 900° C.

19. The method according to claim 18, wherein the heating device sets a reaction temperature for the catalytic reaction in a range between approximately 650° C. and approximately 800° C.
